(19) United States
(12) Patent Application Publication
(10) Pub. No.: US 2013/0332155 A1
(43) Pub. Date: Dec. 12, 2013

(54) Double-Talk Detection for Audio Communication

(71) Applicants: Vinod Prakash, Redmond, WA (US); Xiaoqin Sun, Redmond, WA (US); Warren Lam, Redmond, WA (US); Qin Li, Houston, TX (US)

(72) Inventors: Vinod Prakash, Redmond, WA (US); Xiaoqin Sun, Redmond, WA (US); Warren Lam, Redmond, WA (US); Qin Li, Houston, TX (US)

(73) Assignee: MICROSOFT CORPORATION, Redmond, WA (US)

(21) Appl. No.: 13/490,063

(22) Filed: Jun. 6, 2012

(51) Int. Cl. G10L 21/02; G10L 21/00

(52) U.S. Cl. 704/226; 704/201; 704/E21.002

(57) ABSTRACT

The detection of double-talk in audio communication is provided. A communication device may receive an echo signal mixed with a speech signal at a near end location. The echo signal may be generated by speech transmitted by a remote party at a far end location to a local party at the near end location. The speech signal may be received from the local party for transmission to the remote party. The communication device may then filter the echo signal and the speech signal. The communication device may then analyze the speech signal to identify speech characteristics which indicate the presence of double-talk. The communication device may then set a flag upon identifying the speech characteristics which indicate the presence of the double-talk. The communication device may then process the filtered signals to further suppress remaining echo prior to transmission of the speech signal to the remote party.

### COPYRIGHT NOTICE

A portion of the disclosure of this patent document may contain material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

In bi-directional voice communication systems, acoustic echo is a common and potentially severe problem. In typical bi-directional voice communication systems, audio from a conversation with remote parties is rendered over a speaker in a local party communication device as well as captured by a microphone in the same device thereby forming an echo. Consequently, audio received by a local party at the microphone is transmitted along with the echo back to a remote party during the conversation, resulting in corrupted audio. Previous solutions to this problem include the use of acoustic echo cancellation (“AEC”) for the removal of the echo prior to it reaching the remote party. However, current AEC functionality is compromised during instances of “double-talk” in a conversation (i.e., when the audio from the local party (i.e., “near end audio”) and echo are both present at the same time). In particular, because near end audio and echo are typically both speech signals with indistinguishable statistical properties, existing AEC techniques for identifying double-talk may result in detection errors as well as the misapplication of echo control methods (e.g., suppressing the near end audio from the local party resulting in distorted speech being received by the remote party). It is with respect to these considerations and others that the various embodiments described herein have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for detecting double-talk in audio communication. A communication device may receive an echo signal mixed with a speech signal at a near end location. The echo signal may be generated by speech transmitted by a remote party at a far end location to a local party at the near end location. The speech signal may be received from the local party for transmission to the remote party. The communication device may then filter the echo signal and the speech signal. The communication device may then analyze the speech signal to identify speech characteristics which indicate the presence of double-talk. The communication device may then set a flag upon identifying the speech characteristics which indicate the presence of the double-talk. The communication device may then process the filtered signals to further suppress remaining echo prior to transmission of the speech signal to the remote party.

These and other features and advantages will be apparent from a reading of the following detailed description and a review of the associated drawings. It is to be understood that both the foregoing general description and the following detailed description are illustrative only and are not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

FIG. 1 is a block diagram showing a communication device for detecting double-talk in an audio communication between multiple parties, in accordance with an embodiment;

FIG. 2 is a block diagram showing an acoustic echo canceller (“AEC”) in the communication device of FIG. 1 which may be utilized for detecting double-talk, in accordance with an embodiment;

FIG. 3 is a flow diagram illustrating a routine for detecting double-talk in an audio communication, in accordance with an embodiment;

FIG. 4 is a simplified block diagram of a computing device with which various embodiments may be practiced;

FIG. 5A is a simplified block diagram of a mobile computing device with which various embodiments may be practiced;

FIG. 5B is a simplified block diagram of a mobile computing device with which various embodiments may be practiced; and

FIG. 6 is a simplified block diagram of a distributed computing system in which various embodiments may be practiced.

### DETAILED DESCRIPTION

Embodiments are provided for detecting double-talk in audio communication. A communication device may receive an echo signal mixed with a speech signal at a near end location. The echo signal may be generated by speech transmitted by a remote party at a far end location to a local party at the near end location. The speech signal may be received from the local party for transmission to the remote party. The communication device may then filter the echo signal and the speech signal. The communication device may then analyze the speech signal to identify speech characteristics which indicate the presence of double-talk. The communication device may then set a flag upon identifying the speech characteristics which indicate the presence of the double-talk. The communication device may then process the filtered signals to further suppress remaining echo prior to transmission of the speech signal to the remote party.

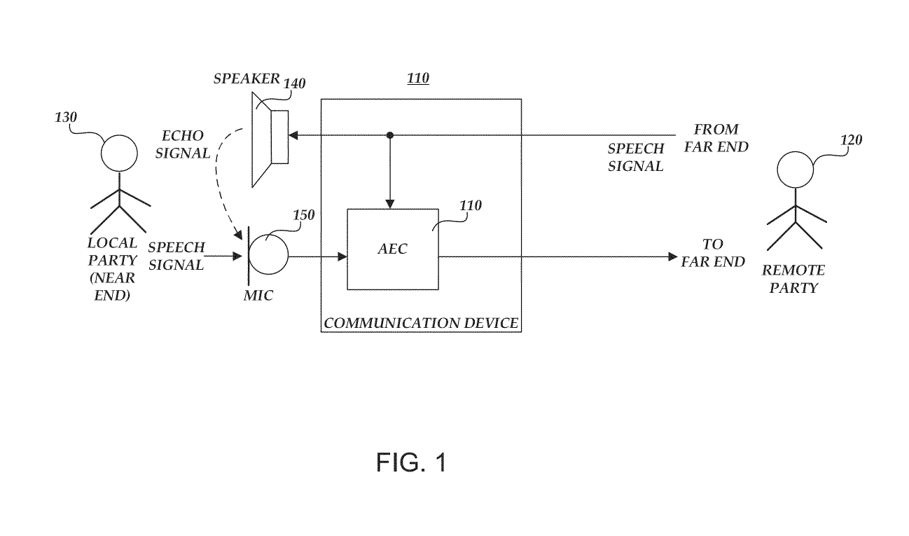

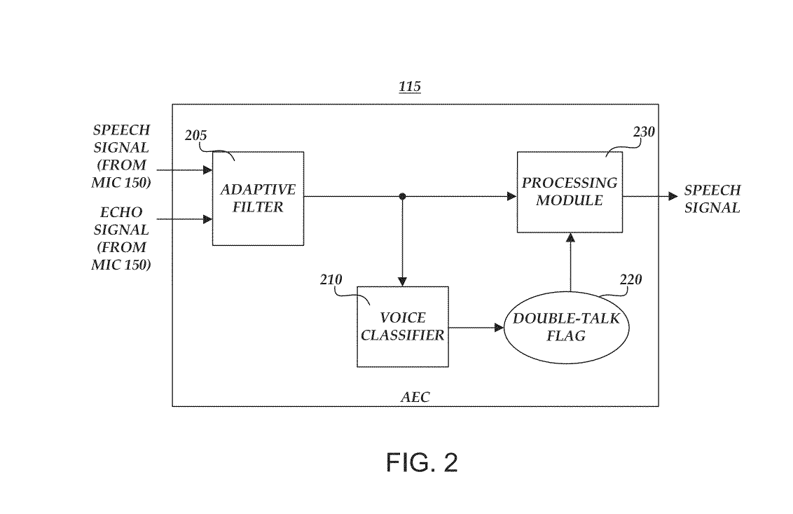

FIG. 1 shows a communication device 100 for detecting double-talk in an audio communication between multiple parties, in accordance with an embodiment. As defined herein, double-talk is simultaneous speech in an audio communication over a communication device between at least two parties in a conversation. It should be understood, that in accordance with various embodiments, the communication device 100 may comprise any number of devices configured for bi-directional voice communication including, but not limited to, a telephone which includes a handset, a speakerphone and a computing device configured for telephony functions over a computer network. The communication device 100 may include an acoustic echo canceller (“AEC”) 110. The AEC 110 in the communication device 100 may further be communicatively coupled to a speaker 140 and a microphone 150. The communication device 100 may receive speech from a remote party 120 (i.e., from a “far end” location of a conversation) for transmission to a local party 130 (i.e., at a “near end” location of a conversation) over the speaker 140. The communication device 100 may also receive speech from the local party 130 over the microphone 150 for transmission to the remote party 120 thereby establishing a bi-directional voice communication between the remote party 120 and the local party 130. As will be described in greater detail below with respect to FIG. 2, the AEC 110 may be utilized for the cancellation of an echo signal which is generated when speech from the remote party 120, which is rendered by the speaker 140, is captured by the microphone 150 thereby forming an echo at the near end location. As will also be described below, the AEC 110 may further be utilized to detect double-talk in the bi-directional voice communication between the remote party 120 and the local party 130 and to determine a level of suppression which is appropriate for cancelling echo signals when double-talk is present in a conversation. It should be understood, that in accordance with various embodiments, the functionality of the AEC 110 may be implemented as a hardware device or alternatively as software comprising computer-executable instructions which are executed on a computing device. In accordance with an embodiment, the functionality of the AEC 110 may be provided by the LYNC communications software from MICROSOFT CORPORATION of Redmond, Wash. It should be understood, however, that other communications software from other manufacturers may be utilized in accordance with the various embodiments described herein.

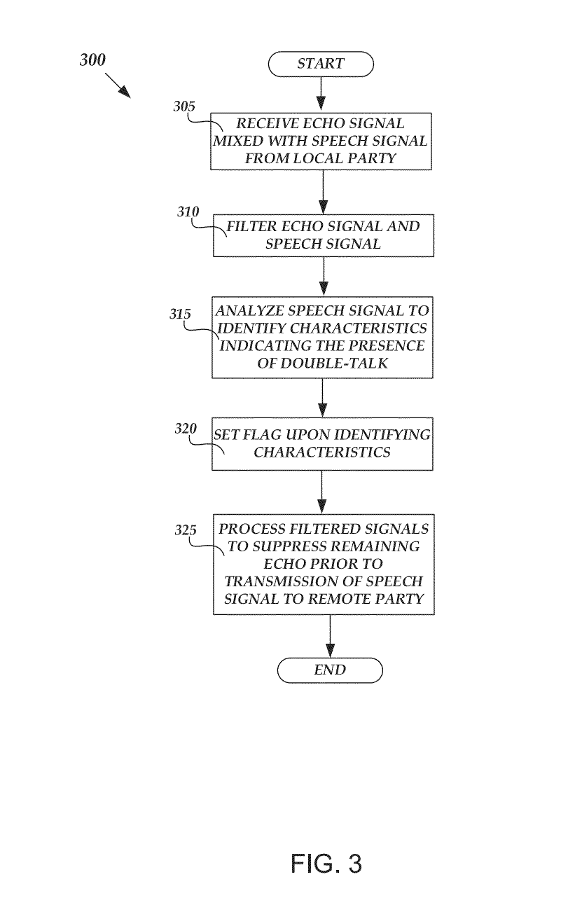

FIG. 2 is a block diagram showing the AEC 110 in the communication device 100 of FIG. 1, which may be utilized for detecting double-talk, in accordance with an embodiment. The AEC 110 may include an adaptive filter 205, a voice classifier 210 and a processing module 230. As will be described in greater detail below with respect to FIG. 3, the adaptive filter 205 may be configured to receive the speech and echo signals captured by the microphone 150 in the communication device 100 of FIG. 1. The adaptive filter 205 may further function to filter the echo and speech signals by distorting speech characteristics associated with the echo signal. The voice classifier 210 may be configured to analyze the speech signal received by the adaptive filter 205 to identify speech characteristics indicating the presence of double-talk, set a double-talk flag 220 upon making a positive identification of double-talk, classify the speech characteristics in the speech signal as valid speech, and classify the distorted speech characteristics associated with the echo signal as non-speech. The processing module 230 may be configured to process the filtered signals by suppressing the remaining echo to prevent audio distortion from being included with the speech signal upon being received by the remote party.

FIG. 3 is a flow diagram illustrating a routine 300 for detecting double-talk in an audio communication, in accordance with an embodiment. When reading the discussion of the routines presented herein, it should be appreciated that the logical operations of various embodiments are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the various embodiments. Accordingly, the logical operations illustrated in FIG. 3 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the various embodiments as recited within the claims set forth herein.

The routine 300 begins at operation 305, where the AEC 110 in the communication device 100 of FIG. 1 may receive an echo signal, from the remote party 120 at the far end location, which is mixed with a speech signal from the local party 130, at the near end location. In particular, the adaptive filter 205 (see FIG. 2) in the AEC 110 may receive the echo signal mixed with the speech signal.

From operation 305, the routine 300 continues to operation 310, where the AEC 110 in the communication device 100 of FIG. 1 may filter the echo and speech signals received at operation 305. In particular, the adaptive filter 205 (see FIG. 2) in the AEC 110 may distort speech characteristics associated with the echo signal to facilitate cancelling the echo. It should be appreciated by those skilled in the art that, prior to filtering, echo signals and speech signals may be nearly indistinguishable since both signals contain speech characteristics (i.e., detectable speech structures).

From operation 310, the routine 300 continues to operation 315, where the AEC 110 in the communication device 100 of FIG. 1 may analyze the speech signal received at operation 310 to identify speech characteristics which identify the presence of double-talk. In particular, the voice classifier 210 (see FIG. 2) in the AEC 110 may analyze the speech signal and classify the speech characteristics in the speech signal as valid speech while classifying the distorted speech characteristics associated with the echo signal as non-speech. It should be appreciated that the presence of both valid speech and non-speech indicates the presence of double-talk. As should be understood by those skilled in the art, speech characteristics in non-distorted speech generate a highly visible spectrogram plot due to the presence of intact speech features (such as formants) while, conversely, distorted speech characteristics generate a distinctly less visible spectrogram plot due to a low number of speech structures in the filtered echo signal.

From operation 315, the routine 300 continues to operation 320, where the AEC 110 in the communication device 100 of FIG. 1 may set a flag upon the identification of the speech characteristics indicating the presence of the double-talk at operation 320. In particular, the voice classifier 210 (see FIG. 2) in the AEC 110 may set the double-talk flag 220 (see FIG. 2) to “true” after classifying the speech characteristics as valid speech at operation 320. In accordance with an embodiment, flag may comprise a binary flag (i.e., “true” or “false”) where a false designation would indicate the absence of valid speech (e.g., distorted speech characteristics from an echo signal).

From operation 320, the routine 300 continues to operation 325, where the AEC 110 in the communication device 100 of FIG. 1 may process the filtered signals (i.e., the distorted speech characteristics generated by the adaptive filter 205 of FIG. 2) to suppress remaining echo prior to transmission of the speech signal to the remote party 120. In particular, the processing module 230 (see FIG. 2) in the AEC 110 may receive the double-talk flag 220 from the voice classifier 210 and suppress the remaining echo by suppressing the filtered echo signal to prevent audio distortion (i.e., the distorted speech characteristics) from being included with the speech signal (i.e., the speech signal comprising valid speech from the local party 130) upon being received by the remote party 120. It should be understood by those skilled in the art that the processing module 230 may be configured to apply an appropriate level of suppression to speech signals based on the status of the double-talk flag 220. For example, when the flag is set to “true” (thereby indicating the presence of double-talk), the processing module 230 may be configured to apply a light or reduced level of suppression due to the presence of a speech signal containing undistorted speech characteristics (i.e., valid speech). On the other hand, when the flag is set to “false” (thereby indicating the absence of double-talk), the processing module 230 may be configured to apply a heavy or aggressive level of suppression because the only signal present is the filtered echo signal which contains distorted speech characteristics (i.e., undesired noise distortion). It should be understood that the processing module 230 in the AEC 110 may be configured to retrieve speech statistics with respect to the echo signal to determine the level of suppression to apply. For example, the processing module 230 may determine a relative strength of the echo signal based on a comparison of a speech signal generated by the local party 130. Thus, the processing module 230 may determine the amount of suppression to apply based on the difference between the strength of the two signals. From operation 325, the routine 300 then ends.

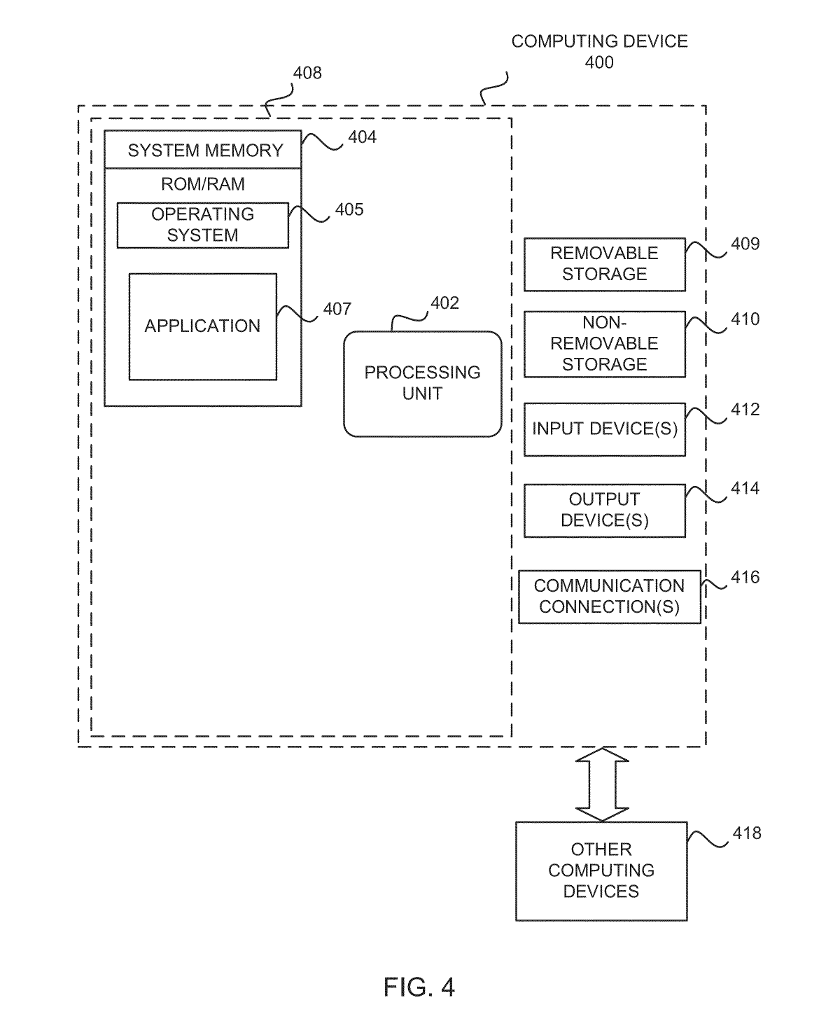

FIG. 4 is a block diagram illustrating example physical components of a computing device 400 with which various embodiments may be practiced. The computing device components described below may be suitable for the communication device 100 described above with respect to FIG. 1. In a basic configuration, the computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include an operating system 405 and applications 407. Operating system 405, for example, may be suitable for controlling computing device 400's operation and, in accordance with an embodiment, may comprise the WINDOWS operating systems from MICROSOFT CORPORATION of Redmond, Wash. It should be understood that the embodiments described herein may also be practiced in conjunction with other operating systems and application programs and further, is not limited to any particular application or system.

The computing device 400 may have additional features or functionality. For example, the computing device 400 may also include additional data storage devices (removable and/or non-removable) such as, for example, magnetic disks, optical disks, solid state storage devices (“SSD”), flash memory or tape. Such additional storage is illustrated in FIG. 4 by a removable storage 409 and a non-removable storage 410.

Generally, consistent with various embodiments, program modules may be provided which include routines, programs, components, data structures, and other types of structures that may perform particular tasks or that may implement particular abstract data types. Moreover, various embodiments may be practiced with other computer system configurations, including hand-held devices, multiprocessor systems, microprocessor-based or programmable consumer electronics, minicomputers, mainframe computers, and the like. Various embodiments may also be practiced in distributed computing environments where tasks are performed by remote processing devices that are linked through a communications network. In a distributed computing environment, program modules may be located in both local and remote memory storage devices.

Furthermore, various embodiments may be practiced in an electrical circuit comprising discrete electronic elements, packaged or integrated electronic chips containing logic gates, a circuit utilizing a microprocessor, or on a single chip containing electronic elements or microprocessors. For example, various embodiments may be practiced via a system-on-a-chip (“SOC”) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein may operate via application-specific logic integrated with other components of the computing device/system 400 on the single integrated circuit (chip). Embodiments may also be practiced using other technologies capable of performing logical operations such as, for example, AND, OR, and NOT, including but not limited to mechanical, optical, fluidic, and quantum technologies. In addition, embodiments may be practiced within a general purpose computer or in any other circuits or systems.

Various embodiments, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. The system memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 400. Any such computer storage media may be part of the computing device 400. The computing device 400 may also have input device(s) 412 such as a keyboard, a mouse, a pen, a sound input device (e.g., a microphone), a touch input device, etc. Output device(s) 514 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

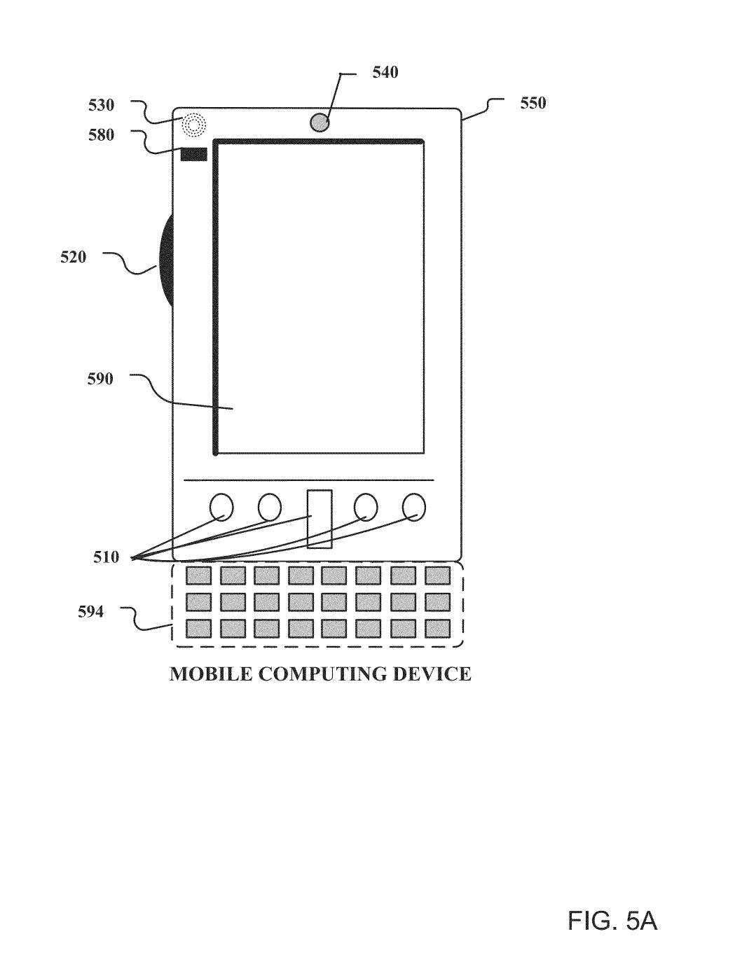

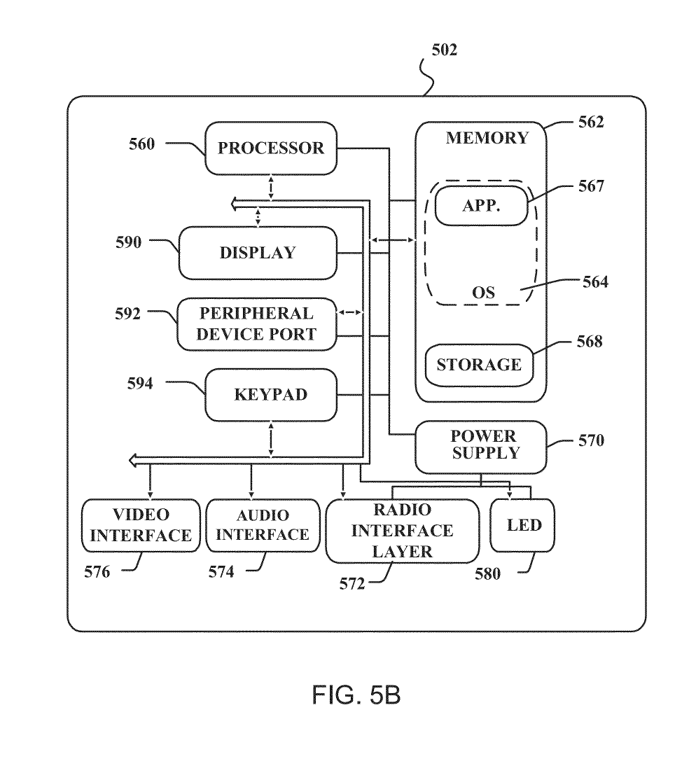

FIGS. 5A and 5B illustrate a suitable mobile computing environment, for example, a mobile computing device 550 which may include, without limitation, a smartphone, a tablet personal computer, a laptop computer, and the like, with which various embodiments may be practiced. With reference to FIG. 5A, an example mobile computing device 550 for implementing the embodiments is illustrated. In a basic configuration, mobile computing device 550 is a handheld computer having both input elements and output elements. Input elements may include touch screen display 525 and input buttons 510 that allow the user to enter information into mobile computing device 550. Mobile computing device 550 may also incorporate an optional side input element 520 allowing further user input. Optional side input element 520 may be a rotary switch, a button, or any other type of manual input element. In alternative embodiments, mobile computing device 550 may incorporate more or less input elements. For example, display 525 may not be a touch screen in some embodiments. In yet another alternative embodiment, the mobile computing device is a portable telephone system, such as a cellular phone having display 525 and input buttons 510. Mobile computing device 550 may also include an optional keypad 505. Optional keypad 505 may be a physical keypad or a “soft” keypad generated on the touch screen display.

Mobile computing device 550 incorporates output elements, such as display 525, which can display a graphical user interface (GUI). Other output elements include speaker 530 and LED light 526. Additionally, mobile computing device 550 may incorporate a vibration module (not shown), which causes mobile computing device 550 to vibrate to notify the user of an event. In yet another embodiment, mobile computing device 550 may incorporate a headphone jack (not shown) for providing another means of providing output signals.

Although described herein in combination with mobile computing device 550, in alternative embodiments may be used in combination with any number of computer systems, such as in desktop environments, laptop or notebook computer systems, multiprocessor systems, micro-processor based or programmable consumer electronics, network PCs, mini computers, main frame computers and the like. Various embodiments may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate the various embodiments described herein.

FIG. 5B is a block diagram illustrating components of a mobile computing device used in one embodiment, such as the mobile computing device 550 shown in FIG. 5A. That is, mobile computing device 550 can incorporate a system 502 to implement some embodiments. For example, system 502 can be used in implementing a “smart phone” that can run one or more applications similar to those of a desktop or notebook computer. In some embodiments, the system 502 is integrated as a computing device, such as an integrated personal digital assistant (PDA) and wireless phone.

Applications 567 may be loaded into memory 562 and run on or in association with an operating system 564. The system 502 also includes non-volatile storage 568 within memory the 562. Non-volatile storage 568 may be used to store persistent information that should not be lost if system 502 is powered down. The applications 567 may use and store information in the non-volatile storage 568. A synchronization application (not shown) also resides on system 502 and is programmed to interact with a corresponding synchronization application resident on a host computer to keep the information stored in the non-volatile storage 568 synchronized with corresponding information stored at the host computer. As should be appreciated, other applications may also be loaded into the memory 562 and run on the mobile computing device 550.

The system 502 has a power supply 570, which may be implemented as one or more batteries. The power supply 570 might further include an external power source, such as an AC adapter or a powered docking cradle that supplements or recharges the batteries.

The system 502 may also include a radio 572 (i.e., radio interface layer) that performs the function of transmitting and receiving radio frequency communications. The radio 572 facilitates wireless connectivity between the system 502 and the “outside world,” via a communications carrier or service provider. Transmissions to and from the radio 572 are conducted under control of OS 564. In other words, communications received by the radio 572 may be disseminated to the applications 567 via OS 564, and vice versa.

The radio 572 allows the system 502 to communicate with other computing devices, such as over a network. The radio 572 is one example of communication media. The embodiment of the system 502 is shown with two types of notification output devices: an LED 580 that can be used to provide visual notifications and an audio interface 574 that can be used with speaker 530 to provide audio notifications. These devices may be directly coupled to the power supply 570 so that when activated, they remain on for a duration dictated by the notification mechanism even though processor 560 and other components might shut down for conserving battery power. The LED 580 may be programmed to remain on indefinitely until the user takes action to indicate the powered-on status of the device. The audio interface 574 is used to provide audible signals to and receive audible signals from the user. For example, in addition to being coupled to speaker 530, the audio interface 574 may also be coupled to a microphone (not shown) to receive audible input, such as to facilitate a telephone conversation. In accordance with embodiments, the microphone may also serve as an audio sensor to facilitate control of notifications. The system 502 may further include a video interface 576 that enables an operation of on-board camera 530 to record still images, video streams, and the like.

A mobile computing device implementing the system 502 may have additional features or functionality. For example, the device may also include additional data storage devices (removable and/or non-removable) such as, magnetic disks, optical disks, or tape. Such additional storage is illustrated in FIG. 5B by storage 568.

Data/information generated or captured by the mobile computing device 550 and stored via the system 502 may be stored locally on the mobile computing device 550, as described above, or the data may be stored on any number of storage media that may be accessed by the device via the radio 572 or via a wired connection between the mobile computing device 550 and a separate computing device associated with the mobile computing device 550, for example, a server computer in a distributed computing network such as the Internet. As should be appreciated such data/information may be accessed via the mobile computing device 550 via the radio 572 or via a distributed computing network. Similarly, such data/information may be readily transferred between computing devices for storage and use according to well-known data/information transfer and storage means, including electronic mail and collaborative data/information sharing systems.

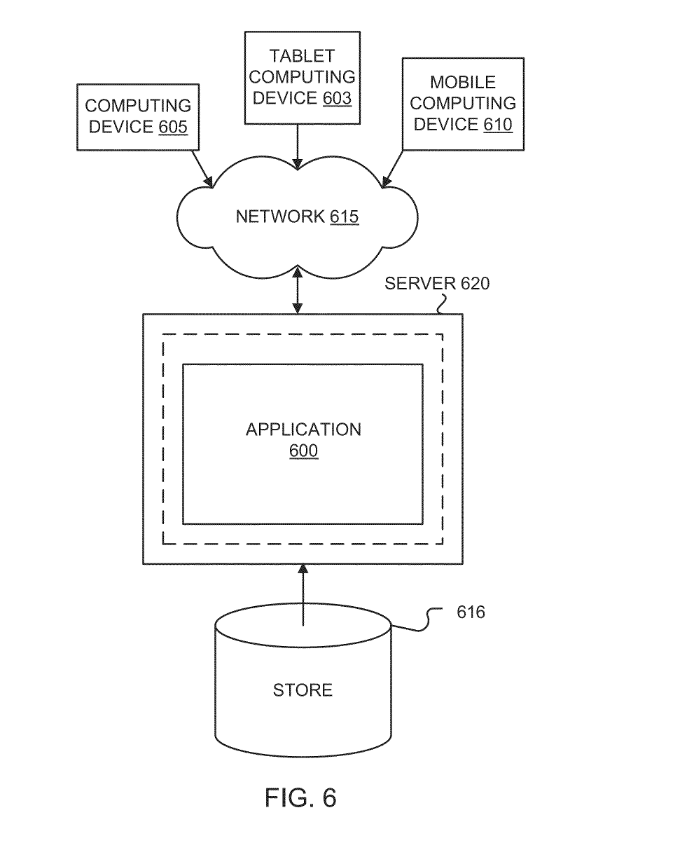

FIG. 6 is a simplified block diagram of a distributed computing system in which various embodiments may be practiced. The distributed computing system may include number of client devices such as a computing device 605, a tablet computing device 603 and a mobile computing device 610. The client devices 605, 603 and 610 may be in communication with a distributed computing network 615 (e.g., the Internet). A server 620 is in communication with the client devices 605, 603 and 610 over the network 615. The server 620 may store applications 600 which may be perform routines including, for example, one or more of the operations in the routine 300 described above.

Various embodiments are described above with reference to block diagrams and/or operational illustrations of methods, systems, and computer program products. The functions/acts noted in the blocks may occur out of the order as shown in any flow diagram. For example, two blocks shown in succession may in fact be executed substantially concurrently or the blocks may sometimes be executed in the reverse order, depending upon the functionality/acts involved.

While certain embodiments have been described, other embodiments may exist. Furthermore, although various embodiments have been described as being associated with data stored in memory and other storage mediums, data can also be stored on or read from other types of computer-readable media, such as secondary storage devices (i.e., hard disks, floppy disks, or a CD-ROM), a carrier wave from the Internet, or other forms of RAM or ROM. Further, the disclosed routines' operations may be modified in any manner, including by reordering operations and/or inserting or operations, without departing from the embodiments described herein.

It will be apparent to those skilled in the art that various modifications or variations may be made without departing from the scope or spirit of the embodiments described herein. Other embodiments will be apparent to those skilled in the art from consideration of the specification and practice of the embodiments described herein.

What is claimed is:

1. A method of detecting double-talk in an audio communication, comprising:
receiving, by a communication device, an echo signal mixed with a speech signal at a near end location, the echo signal being generated by speech transmitted by a remote party at a far end location to a local party at the near end location, the speech signal being received from the local party for transmission to the remote party;
filtering, by the communication device, the echo signal and the speech signal;
analyzing, by the communication device, the speech signal to identify speech characteristics which indicate the presence of double-talk;
setting, by the communication device, a flag upon identifying the speech characteristics which indicate the presence of the double-talk; and
processing, by the communication device, the filtered signals to further suppress remaining echo prior to transmission of the speech signal to the remote party.

2. The method of claim 1, wherein filtering, by the communication device, the echo signal and the speech signal comprises distorting speech characteristics associated with the echo signal.

3. The method of claim 2, wherein analyzing, by the communication device, the speech signal to identify speech characteristics which indicate the presence of double-talk comprises:
classifying the speech characteristics in the speech signal as valid speech; and
classifying the distorted speech characteristics associated with the echo signal as non-speech.

4. The method of claim 1, wherein processing, by the communication device, the filtered signals to further suppress remaining echo prior to transmission of the speech signal to the remote party comprises suppressing the filtered echo signal to prevent audio distortion from being included with the speech signal upon being received by the remote party.

5. The method of claim 1, wherein receiving, by a communication device, an echo signal comprises receiving the echo signal at a microphone in a speakerphone at the near end location.

6. The method of claim 1, wherein receiving, by a communication device, an echo signal comprises receiving the echo signal at a microphone in a telephone handset at the near end location.

7. The method of claim 1, wherein receiving, by the communication device, a speech signal from the local party at the near end location for transmission to the remote party comprises receiving the speech signal at a microphone in a speakerphone at the near end location.

8. The method of claim 1, wherein receiving, by the communication device, a speech signal from the local party at the near end location for transmission to the remote party comprises receiving the speech signal at a microphone in a telephone handset at the near end location.

9. A bi-directional voice communication device comprising:
a memory for storing executable program code; and
a processor, functionally coupled to the memory, the processor being responsive to computer-executable instructions contained in the program code and operative to:
receive an echo signal mixed with a speech signal at a near end location, the echo signal being generated by speech transmitted by a remote party at a far end location to a local party at the near end location, the speech signal being received from the local party for transmission to the remote party;
filter the echo signal and the speech signal;
analyze the speech signal to identify speech characteristics which identify the presence of double-talk, the double-talk comprising simultaneous speech from the local party and the remote party;
set a double-talk flag to true upon identifying the speech characteristics which indicate the presence of the double-talk; and
process the filtered signals to further suppress remaining echo prior to transmission of the speech signal the remote party.

10. The device of claim 9, wherein the processor, in filtering the echo signal and the speech signal, is operative to utilize an adaptive filter in an acoustic echo canceller to distort speech characteristics associated with the echo signal.

11. The device of claim 10, wherein the processor, in analyzing the speech signal to identify speech characteristics which indicate the presence of double-talk, is operative to:
classify the speech characteristics in the speech signal as valid speech; and
classify the distorted speech characteristics associated with the echo signal as non-speech.

12. The device of claim 9, wherein the processor, in processing the filtered signals to further suppress remaining echo prior to transmission of the speech signal to the remote party, is operative to suppress the filtered echo signal to prevent distortion from being included with the speech signal upon being received by the remote party.

13. The device of claim 9, wherein the echo signal is received by a microphone at the near end location.

14. The device of claim 9, wherein the speech signal is received by a microphone at the near end location.

15. The device of claim 9, wherein the echo signal is filtered by an adaptive filter in an acoustic echo canceller.

16. The device of claim 9, wherein the speech signal is filtered by an adaptive filter in an acoustic echo canceller.

17. A computer-readable storage medium comprising computer executable instructions which, when executed by a computing device, will cause the computing device to perform a method of detecting double-talk in an audio communication, comprising:
receiving an echo signal mixed with a speech signal at a near end location, the echo signal being generated by speech transmitted by a remote party at a far end location to a local party at the near end location, the speech signal being received from the local party for transmission to the remote party;
filtering, by an adaptive filter in an acoustic echo canceller, the echo signal and the speech signal;
analyzing the speech signal to identify speech characteristics which indicate the presence of double-talk by:
classifying the speech characteristics in the speech signal as valid speech; and
classifying the distorted speech characteristics associated with the echo signal as non-speech;
setting a binary flag to true upon identifying the speech characteristics which indicate the presence of the double-talk, the double-talk comprising simultaneous speech from the local party and the remote party; and
processing the filtered signals to further suppress remaining echo prior to transmission of the speech signal to the remote party, the filtered signals being processed by suppressing the filtered echo signal to prevent audio distortion from being included with the speech signal upon being received by the remote party.

18. The computer-readable storage medium of claim 17, wherein filtering, by an adaptive filter in an acoustic echo canceller, the echo signal and the speech signal comprises distorting speech characteristics associated with the echo signal.

19. The computer-readable storage medium of claim 17, wherein the echo signal is received by a microphone in the computing device at the near end location.

20. The computer-readable storage medium of claim 17, wherein the speech signal is received by a microphone in the computing device at the near end location.
